(19) United States
(12) Patent Application Publication
(10) Pub. No.: US 2018/0206692 A1
(43) Pub. Date: Jul. 26, 2018

(54) WIPE FOR CLEANING BBQ GRILLS

(71) Applicant: Proud Grill Company Limited, King City (CA)

(72) Inventor: Paul Cira, Toronto (CA)

(21) Appl. No.: 15/878,796

(22) Filed: Jan. 24, 2018

Related U.S. Application Data
(63) Continuation-in-part of application No. 29/591,892, filed on Jan. 25, 2017.
Application No. 29/591,892 is a continuation-in-part of application No. 29/617,355, filed on Sep. 13, 2017.
Application No. 29/617,355 is a continuation-in-part of application No. 29/617,359, filed on Sep. 13, 2017.
Application No. 29/617,359 is a continuation-in-part of application No. 29/617,363, filed on Sep. 13, 2017.
(60) Provisional application No. 62/450,143, filed on Jan. 25, 2017.

(51) Int. Cl. A47L 13/16; D04H 1/492; D04H 1/4258; D04H 1/435

(52) U.S. Cl. CPC A47L 13/16; D04H 1/492; A47J 37/0786; D04H 1/435; D04H 1/4258

(57) ABSTRACT

A cleaning wipe and a method of using the same to clean surfaces such as BBQ grills. The wipe has a plurality of nodules extending outwardly from a base layer. The nodules are arranged in a pattern and present a number of faces that are oriented at different angles relative to each other. The base layer may be fabricated from a non-woven, spunlace, fibrous material and the nodules may be formed from different material such as PVC or rubber. Abrasive particles may be embedded in one or both of the base layer and nodules. The cleaning wipe may be grasped and brushed against the surface of the grill. The differently angled faces on the nodules provide for multi-directional scraping and removal of food, grease, grime and other materials stuck on the grill's surface.

### CROSS REFERENCE TO RELATED APPLICATIONS

This application claims the benefit of U.S. Provisional Application Ser. No. 62/450,143, filed Jan. 25, 2017, the disclosure of which is incorporated herein by reference.

This application is a Continuation-in-Part of U.S. Design patent application Ser. No. 29/591,892 filed Jan. 25, 2017, the disclosure of which is incorporated herein by reference.

This application is a Continuation-in-Part of U.S. Design patent application Ser. No. 29/617,355 filed Sep. 13, 2017, the disclosure of which is incorporated herein by reference.

This application is a Continuation-in-Part of U.S. Design patent application Ser. No. 29/617,359 filed Sep. 13, 2017, the disclosure of which is incorporated herein by reference.

This application is a Continuation-in-Part of U.S. Design patent application Ser. No. 29/617,363 filed Sep. 13, 2017, the disclosure of which is incorporated herein by reference.

### BACKGROUND OF THE INVENTION

### Technical Field

This invention relates generally to cleaning equipment. More particularly, this invention relates to tools for removal of food, grease and grime and other materials stuck onto a surface of a BBQ grill. Specifically, this invention is directed to a cleaning wipe having a plurality of nodules extending outwardly from a base layer; where the nodules are arranged in a pattern and present a number of faces oriented at different angles and wherein the cleaning wipe provides for multi-directional removal of materials from a BBQ grill's surface.

### Background Information

Cooking on a BBQ frequently results in pieces of partially cooked, fully cooked or burned food, grease, and/or grime becoming stuck to a surface of the grill. Wire brushes and scrapers are commonly used to try and remove these stuck materials from the grill's surface. It has recently been realized that, on occasion, small pieces of wire bristles or metal break off from the metal brushes and scrapers used to remove these materials. These small pieces of metal or bristles may become embedded in uncooked food that is placed on the “cleaned” grill surfaces and as a result these metal or wire bristle pieces may be ingested and cause injury or illness.

### SUMMARY

There is therefore a need in the art for an improved article and method of cleaning BBQ grills that does not include metal, bristles or wire.

The omnidirectional cleaning wipe disclosed herein is useful for removing food, grease, grime and any other materials that may adhere to BBQ grill surfaces. The cleaning wipe is metal-free, wire-free, and bristle free and may be fabricated from a material that does not tend to leave particles on the grill surfaces that could later become embedded in foodstuffs subsequently placed on the grill.

A cleaning wipe and a method of using the same to clean surfaces such as those on BBQ grills is disclosed herein. The wipe has a plurality of nodules extending outwardly from a base layer. The nodules are arranged in a pattern and present a number of faces that are oriented at different angles relative to each other. The base layer may be fabricated from a non-woven, spunlace, fibrous material and the nodules may be formed from different material such as PVC or rubber. Abrasive particles may be embedded in one or both of the base layer and nodules. The cleaning wipe may be grasped and brushed against the surface of the grill. The differently angled faces on the nodules provide for multi-directional scraping and removal of food, grease, grime and any other materials stuck on the grill's surface. It is contemplated that a new wipe will be used every time the grill is cleaned and this ensures that a user is not cleaning their BBQ grill with a dirty, previously used cleaning instrument.

In one aspect, the invention may provide a cleaning wipe for removing stuck materials from an object's surface, said cleaning wipe comprising a base layer having a front surface and a back surface; and a plurality of nodules extending for a distance outwardly from one or both of the front surface or the back surface of the base layer.

In another aspect, the invention may provide in combination a support device; and a cleaning wipe for removing stuck materials from an object's surface, said cleaning wipe comprising a base layer having a front surface and a back surface; and a plurality of nodules extending for a distance outwardly from one or both of the front surface or the back surface of the base layer; and wherein the cleaning wipe is selectively detachably engaged with the support device.

In another aspect, the invention may provide a method of removing stuck materials from an object's surface comprising providing a cleaning wipe; moving the cleaning wipe across the object's surface; contacting the materials stuck on the object's surface with a plurality of nodules that extend for a distance outwardly from a front surface or a back surface of the cleaning wipe; and scraping the stuck materials from the object's surface using the plurality of nodules and the front surface or the back surface of the cleaning wipe.

### BRIEF DESCRIPTION OF THE SEVERAL VIEWS OF THE DRAWINGS

A sample embodiment of the invention is set forth in the following description, is shown in the drawings and is particularly and distinctly pointed out and set forth in the appended claims.

FIG. 1 is a front elevation view of a first embodiment of a cleaning wipe in accordance with an aspect of the present disclosure;

FIG. 1A is an enlarged partial cross-section of the cleaning wipe taken along line 1A-1A of FIG. 1 showing nodules on only the front surface of the cleaning wipe;

FIG. 1B is an enlargement of the highlighted region of FIG. 1A showing nodules on only the front surface of the cleaning wipe;

FIG. 1C is an enlargement of the highlighted region of FIG. 1B;

FIG. 1D is an enlargement of a first highlighted region of FIG. 1;

FIG. 1E is an enlargement of a second highlighted region of FIG. 1;

FIG. 1F is cross-section of the cleaning wipe taken along line 1F-1F of FIG. 1E;

FIG. 1G is an enlargement of the cleaning wipe similar to FIG. 1B but showing nodules on the front surface and on the back surface of the cleaning wipe;

FIG. 1H is an enlargement of the cleaning wipe similar to FIG. 1B but showing nodules on only the back surface of the cleaning wipe;

FIG. 2 is a front elevational view of a second embodiment of a cleaning wipe in accordance with an aspect of the present disclosure;

FIG. 2A is an enlarged partial cross-section of the cleaning wipe taken along line 2A-2A of FIG. 2;

FIG. 2B is an enlargement of the highlighted region of FIG. 2A;

FIG. 2C is an enlargement of the highlighted region of FIG. 2;

FIG. 3 is a front elevational view of a third embodiment of a cleaning wipe in accordance with an aspect of the present disclosure;

FIG. 3A is an enlarged partial cross-section of the cleaning wipe taken along line 3A-3A of FIG. 3; and

FIG. 3B is an enlargement of the highlighted region of FIG. 3A;

FIG. 3C is an enlargement of the highlighted region of FIG. 3;

FIG. 4 is a rear perspective view of a cleaning wipe engaged with a support member, where the cleaning wipe is frictionally engaged by a surface of the support member;

FIG. 4A is a rear perspective view of the cleaning wipe engaged with and secured to the support member via clamping members provided on the support member;

FIG. 5 is a cross-section through the support member of FIG. 4 or FIG. 4A showing the cleaning wipe and support member in contact with a BBQ grill and showing the wipe and cleaning pad on the support member contouring to the grill bars;

FIG. 6A is a right side elevation view of the support member of FIG. 4 shown on its own with the pad thereof shown in phantom;

FIG. 6B is a left side elevation view thereof;

FIG. 6C is a front elevation view thereof;

FIG. 6D is a rear elevation view thereof; and

FIG. 6E is a top plan view thereof;

FIG. 7A is a right side elevation of a second embodiment of the support member shown on its own with the pad in phantom;

FIG. 7B is a front elevation view thereof, the unshown rear elevation view being a mirror image thereof; and

FIG. 7C is a top plan view thereof;

FIG. 8A is a right side elevation of a third embodiment of the support member shown on its own with the pad in phantom;

FIG. 8B is a left side elevation view thereof;

FIG. 8C is a front elevation view thereof;

FIG. 8D is a rear elevation view thereof; and

FIG. 8E is a top plan view thereof.

Similar numbers refer to similar parts throughout the drawings.

### DETAILED DESCRIPTION

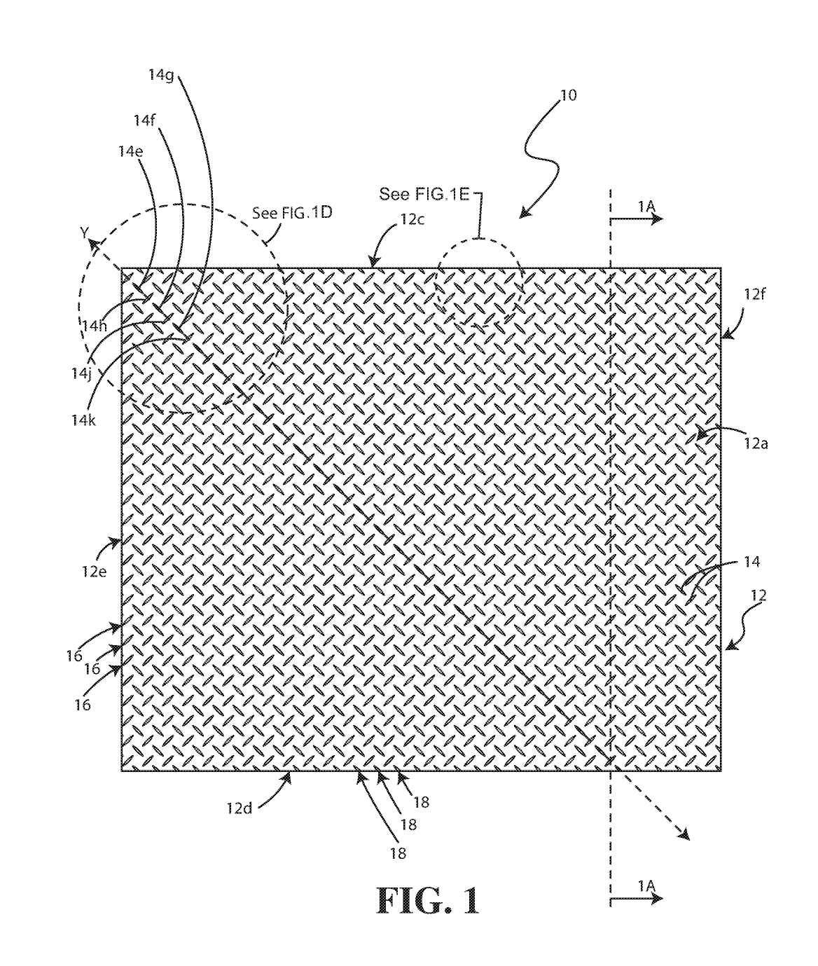

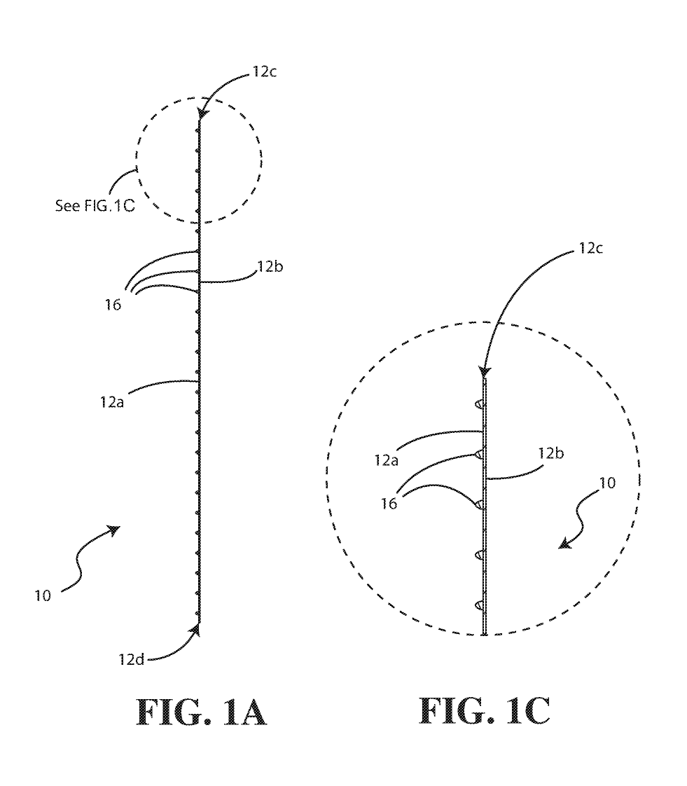

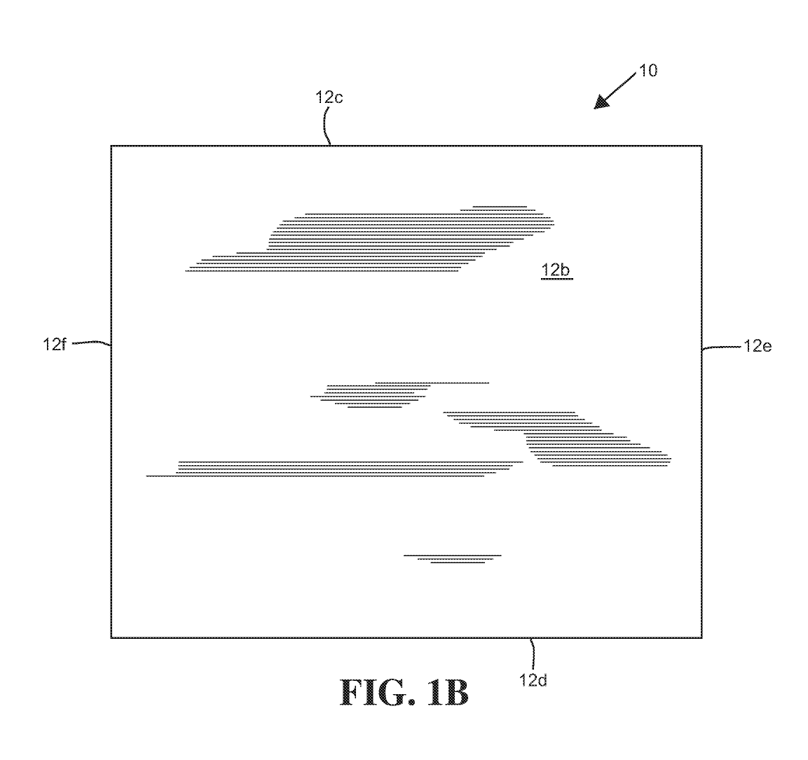

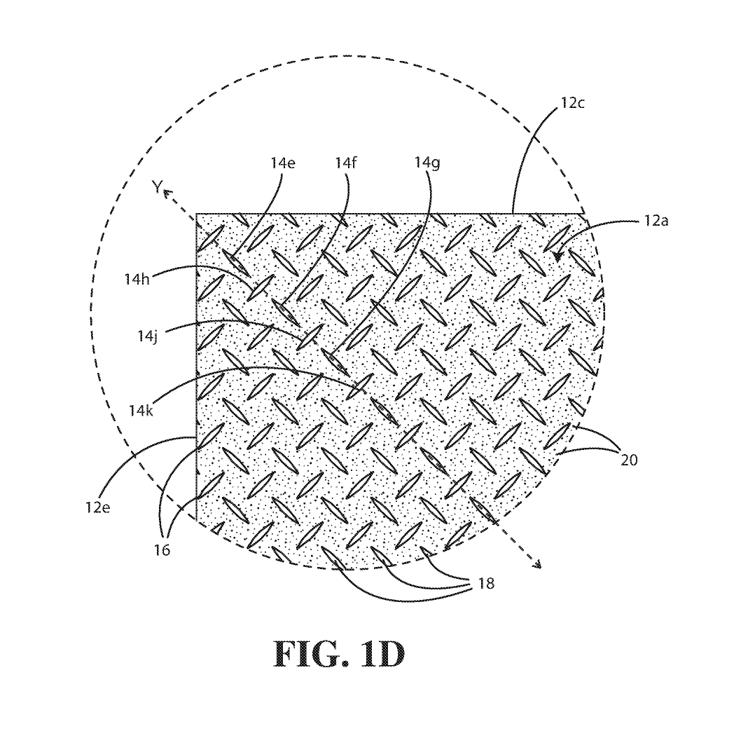

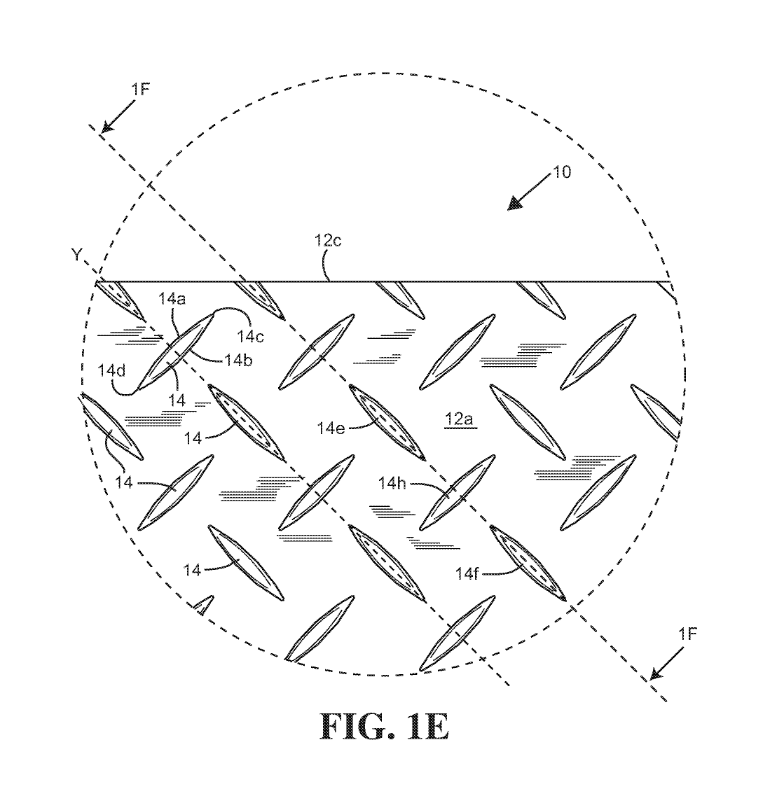

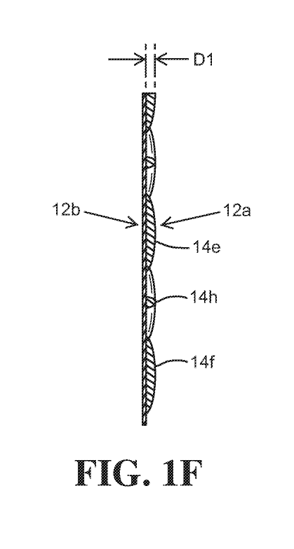

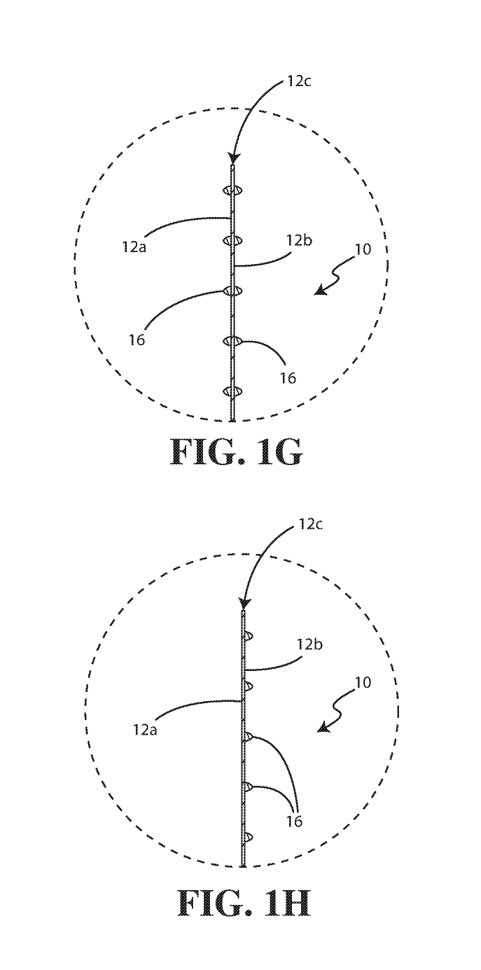

Referring to FIGS. 1 and 1A to 1F there is shown a first embodiment of a cleaning wipe in accordance with an aspect of the present disclosure, generally indicated at 10. Cleaning wipe 10 may comprise a base layer 12 and a plurality of nodules 14 provided on the base layer 12. Base layer 12 may be a non-woven, spunlace fibrous material. The fibrous material may be comprised of about 50% viscose and about 50% polyester. It will be understood, however, that other types of fibrous materials and other percentages of viscose and polyester may be utilized in base layer 12.

FIG. 1 illustrates base layer 12 as being square in shape but it will be understood that base layer 12 may be fabricated in any desired shape. As illustrated, base layer 12 has a front surface 12a, a back surface 12b (FIG. 1A), a first end 12c, a second end 12d, a first side 12e and a second side 12f.

A plurality of nodules 14 may be provided on base layer 12. Nodules 14 may be formed from any suitable material such as polyvinyl chloride (PVC). Another suitable material may be rubber. It will be understood that any other suitable material may be bonded or otherwise secured to base layer 12 so that those materials project for a distance outwardly from a front or rear surface 12a, 12b thereof.

Referring to FIGS. 1A, 1B, 1C, 1D, 1E, 1F, 1G, and 1H, nodules 14 may be applied onto one or both of the front surface 12a and the back surface 12b of base layer in any suitable manner. For instance, the materials to form nodules 14 may be heated and deposited onto front surface 12a only (FIGS. 1A, 1B, 1C, 1E, 1E and 1F) or onto both the front surface 12a and the back surface 12b (FIG. 1G) or onto only the back surface 12b (FIG. 1H). Once the material to form nodules 14 has been deposited onto one or both of front surface 12a and/or back surface 12b, the material is allowed to cool become bonded to the base layer. It will be understood that nodules 14 may be bonded to the fibrous material of base layer 12 using an adhesive and/or using heat. Nodules 14 may, alternatively, be embedded within the fibrous material when base layer 12 is formed and may be positioned to extend from front surface 12a through to back surface 12b.

In accordance with an aspect of the present disclosure, nodules 14 may be provided on base layer in a pattern. The selected pattern may be any desired pattern but one suitable type of pattern is a regular, geometric pattern that is applied over substantially the entire front surface 12a and/or back surface 12b of base layer 12. The pattern ideally will extend from proximate first end 12c of base layer 12 to proximate second end 12 thereof and from proximate first side 12e of base layer 12 to proximate second side 12f thereof. When the pattern does extend from end to end 12c, 12d and from side to side 12e, 12f, substantially the entire surface of cleaning wipe 10 is capable of being used to clean food or other materials from the surface of a grill.

FIGS. 1-1G show an example of a first pattern of nodules 14 provided on base layer 12. In this pattern, each nodule 14 may be a raised elongate shape that extends for a distance “D1” (FIG. 1F) outwardly away from front surface 12a (or from back surface 12b or front and back surfaces 12a, 12b as described above). A pattern of nodules 14 extending outwardly from both the front surface 12a and back surface 12b of base layer 12 is shown in FIG. 1G and a pattern of nodules 14 extending outwardly from only the back surface 12b of base layer 12 is shown in FIG. 1H.

Each nodule 14 has a thin elongate shape when cleaning wipe 10 is viewed from the front as in FIG. 1. The shape of nodule 14 may be generally that of an elongate oval (FIGS. 1D and 1E). The elongate oval has a first face 14a (FIG. 1E) and a second face 14b. Each of the first and second faces 14a, 14b are curved and the curvature of first face 14a is opposite to the curvature of second face 14b. First and second faces 14a, 14b may be opposed to each other and intersect each other at both of a first end 14c and a second end 14d. (Alternatively, nodules 14 may be an elongate, generally rectangular shape having two opposed sides and two opposed ends.)

In accordance with an aspect of the invention, nodules 14 may be arranged in a pattern of intersecting diagonal rows 16, 18 (FIG. 1D). A plurality of nodules 14 is provided in each row 16, 18. Furthermore, in each row 16, 18 the orientation of adjacent nodules 14 alternates relative to a longitudinal axis, “Y” (FIG. 1). The axis “Y” is oriented at about 45 degrees relative to first end 12c and second end 12d and extends along one of the rows 16 or 18 that runs from first end 12c to second end 12d of base layer 12.

As shown in FIGS. 1A and 1D, the plurality of nodules in one of the rows 18 may include a first group of nodules and a second group of nodules. In the first group there is a first nodule 14e, a third nodule 14f, and a fifth nodule 14 g that are spaced at intervals along axis “Y”. Each of the first nodule 14e, third nodule 14f, and fifth nodule 14g are oriented in the same manner with respect to axis “Y”. In particular these nodules 14e, 14f, and 14g are aligned along the axis “Y”; in other words, their ends 14c and 14d fall on axis “Y. All nodules 14 on cleaning wipe 10 having an orientation similar to first nodule 14e, third nodule 14f and fifth nodule 14g are substantially parallel to axis “Y”. In the second group of nodules on cleaning wipe 10, there is a second nodule 14h, a fourth nodule 14j, and a sixth nodule 14k that is oriented generally at right angles to axis “Y”. The second nodule 14h is located between first and third nodules 14e, 14f; the fourth nodule 14j is located between third and fifth nodules 14f, 14g, and sixth nodule 14k is positioned so that fifth nodule 14g is positioned between fourth and sixth nodules 14j, 14k. In other words, nodules from the first group are alternated with nodules from the second group. The relationship between the alternating nodules 14 holds true in every row 16 and in every row 18. In other words, adjacent nodules in each row 16, 18 may be oriented generally at right angles to each other. All nodules 14 on cleaning wipe 10 having an orientation similar to second, fourth and sixth nodules 14h, 14j, and 14k are oriented at right angles to axis “Y”.

It will be understood that rows 16, 18 may be oriented other than on respective diagonals relative to first end 12c and second end 12d of cleaning wipe 10. Furthermore, instead of adjacent nodules 14 being oriented generally at right angles to each other, adjacent nodules may be oriented at any other desired angle relative to each other.

When cleaning wipe 10 is used to remove food, grease, grime or other substances from the surface of a barbeque (BBQ) grill, the user will grasp wipe 10 in one hand and, contacting the grill's surface with wipe 10, sweep the wipe's front surface 12a or back surface 12b across the grill. (It will be understood that cleaning wipe 10 may be used to clean the grilling surface of the BBQ grill or any other surface of the BBQ grill.)

Since base layer 12 is a fibrous layer, base layer 12 will contact and scrape some of the stuck materials from the grill's surfaces. In addition, nodules 14 that extend outwardly for a distance beyond front surface 12a (and/or back surface 12b) will contact materials that may be somewhat stuck onto the grill. Because nodules 14 are arranged in a pattern, because nodules 14 are oriented at different angles relative to each other, and because nodules 14 are formed of a material different from the fibrous material of base layer 12, when wipe is passed across the grill surface stuck materials will be scraped off the grill. In particular, the faces 14a, 14b and ends 14c, 14d of the various differently oriented nodules 14 will push, pull, slice and scrape against food particles, grease, grime and any other materials that may be adhered to the metal surfaces of the grill and will remove the same therefrom. This removal of stuck food particles and other materials will occur if the cleaning wipe 10 is placed flat on the grill's surface or is scrunched up in the user's hand. Gathering the wipe 10 in one hand may introduced even more variability in the angles of nodules 14 relative to each other.

Cleaning wipe 10 thus provides a plurality of elongate, flat, slightly curved faces and slightly pointed ends that extend outwardly from base layer 12 and are oriented in a multitude of directions relative to each other. These elongate, flat, or generally curved protruding surfaces give the cleaning wipe 10 an ability to simultaneously, multi-directionally or omni-directionally wipe clean a grill's surface.

Additionally, because nodules 14 are fabricated from PVC or rubber, no amount of wiping of the grill's surface will result in metal fibers being left on the grill surface as was the case with previously known barbeque cleaning implements. If the grill is somewhat hot when cleaning wipe 10 is used, small amounts of PVC or rubber on cleaning wipe 12 may become heated and therefore become tacky. This tackiness will aid in removing food, grease, grime and other stuck particles from the grill. If any material from nodules 14 is left behind on the grill, that material will simply burn off as the grill continues to be heated by the barbeque grill's burners.

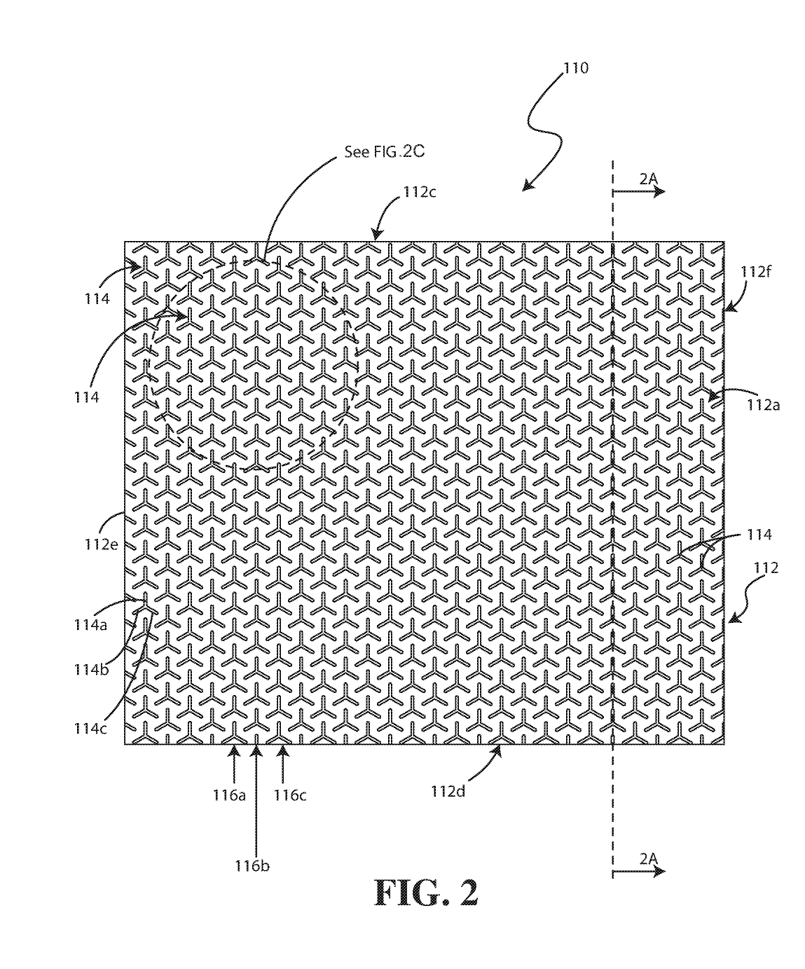

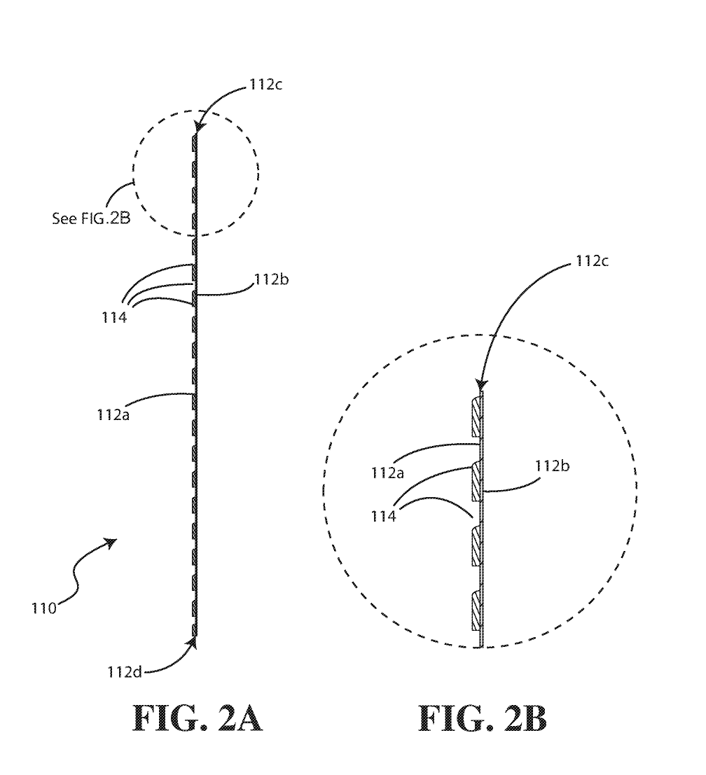

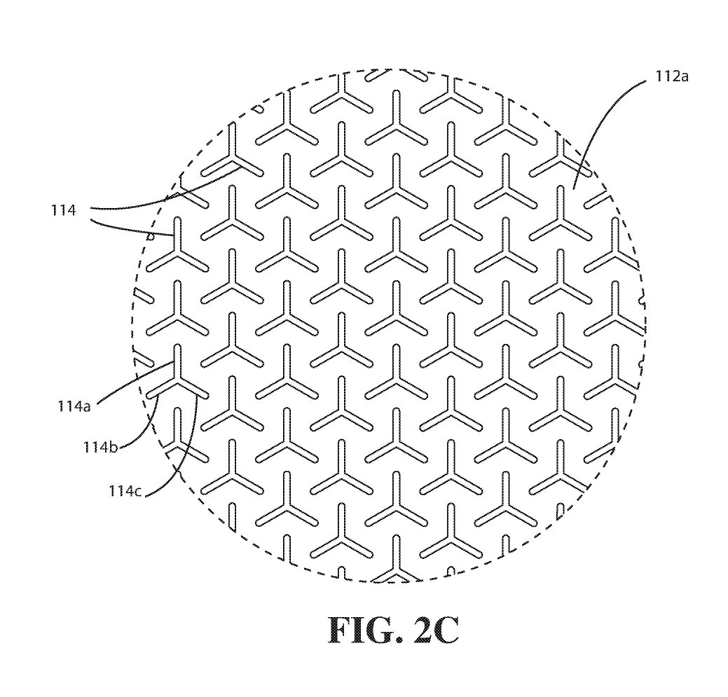

FIGS. 2-2C show a second embodiment of a cleaning wipe in accordance with an aspect of the present disclosure, generally indicated at 210. Cleaning wipe 210 comprises a base layer 112 and a plurality of nodules 114 that may be provided on the base layer 112. Base layer 112 may be a non-woven, spunlace fibrous material. The fibrous material may be comprised of about 50% viscose and about 50% polyester or may be comprised of any suitable material. FIG. 2 illustrates base layer 112 that is square in shape but it will be understood that base layer 112 may be provided in any desired shape. As illustrated, base layer 112 has a front surface 112a, a back surface 112b (FIG. 2A), a first end 112c, a second end 112d, a first side 112e and a second side 112f.

A plurality of nodules 114 may be provided on base layer 112. Nodules 114 may be formed from any suitable material such as polyvinyl chloride (PVC) or rubber that is applied onto one or both of front surface 112a and back surface 112b of base layer 112. Nodules 114 may be bonded to the fibrous material of base layer 112 or may be embedded therein and may extend for a distance outwardly beyond front surface 112a and/or back surface 112b of base layer 112.

In accordance with an aspect of the present disclosure, nodules 114 may be provided on base layer in a different pattern from what is illustrated in FIGS. 1-1G. FIG. 2 shows that each nodule 114 may be formed as a generally Y-shaped nodule. The Y-shaped nodules 114 each include a shaft 114a, a first arm 114b, and a second arm 114c. The Y-shaped nodules 114 may be in an inverted orientation such as is illustrated in FIG. 2 or may be rotated through 90 degrees relative to what is shown in FIG. 2 or oriented at any angle relative to first end 112c. Each nodule 114 may be formed a raised member that projects for a distance outwardly from or beyond the associated front surface 112a upon which nodule 114 is provided. It will be understood by those of ordinary skill in the art that the nodules 114 may be provided on only the front surface 112a, on the front and back surfaces 112a, 112b, or only on the back surface 112b.

The Y-shaped nodules 114 may be arranged in a pattern of a plurality of substantially parallel rows 116a, 116b, and 116c and so on. Nodules 114 in adjacent rows, such as those in rows 116a and 116b may be laterally offset relative to each other meaning that the shaft 114a of each nodule 114 in row 116a does not laterally align with the shaft 114a of each nodule 114 in row 116b. (The term “lateral” with respect to the pattern shown in FIG. 2 refers to a direction extending from first side 112e to second side 112f of cleaning wipe 110 or vice versa.) Nodules 114 in every second row, such as 116a and 116b, may be laterally aligned with each other.

The plurality of nodules 114 on cleaning wipe 110 thus present a plurality of elongate, planar faces that may be oriented at a variety of different angles relative to each other. Because of this, when cleaning wipe 110 is used to scrape food, grease, grime or other materials from a grill surface, the variety of differently angled faces presented by the plurality of nodules 114 on cleaning wipe 110 will engage and scrape off pieces of food, grease, grime or other materials bonded to the grill's surfaces. Cleaning wipe 110 is used in a substantially identical manner to cleaning wipe 110. As with nodules 14, when nodules 114 become tacky because they contact hot metal, the tackiness helps to remove stuck materials.

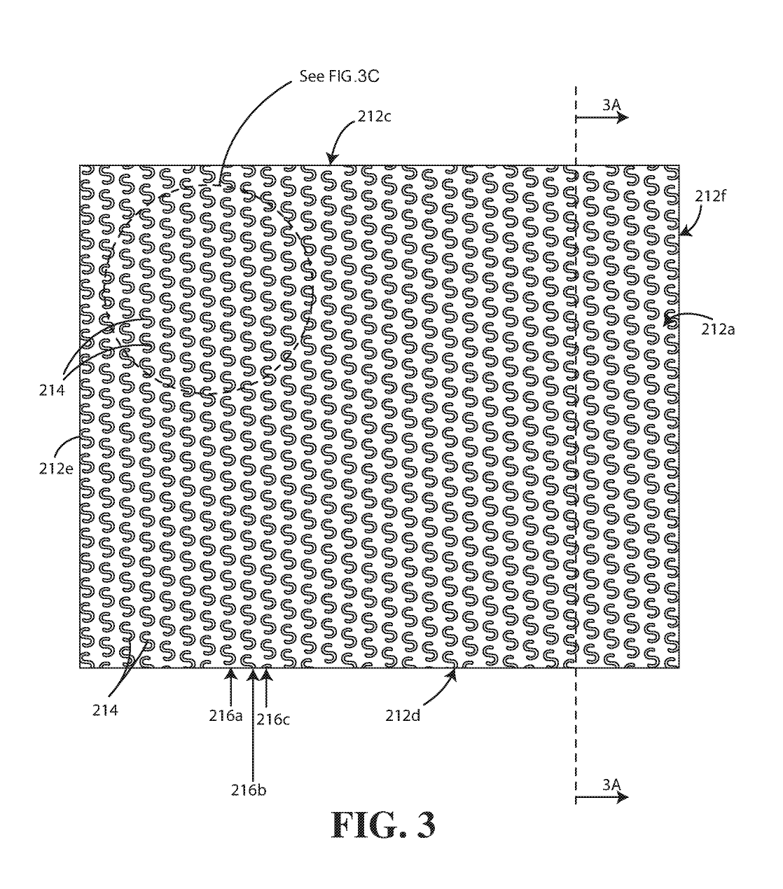

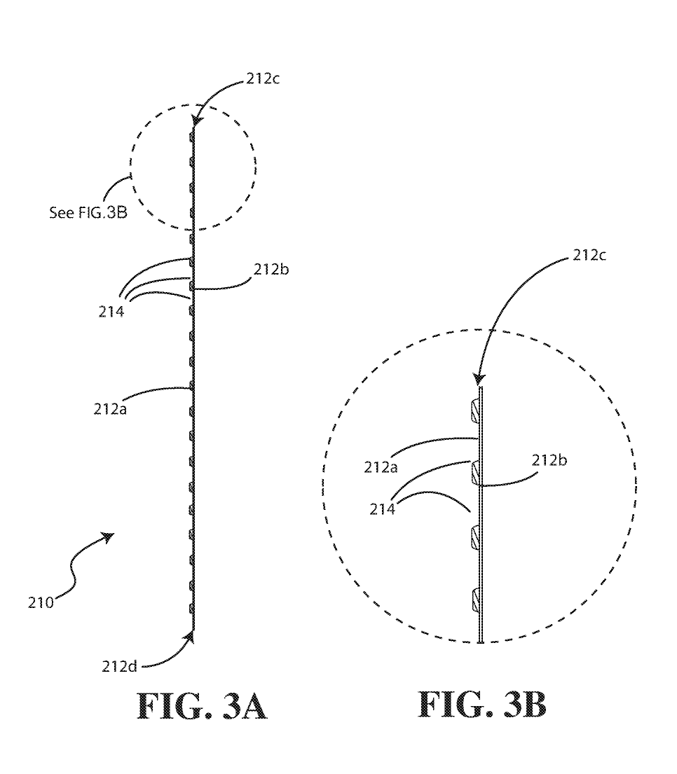

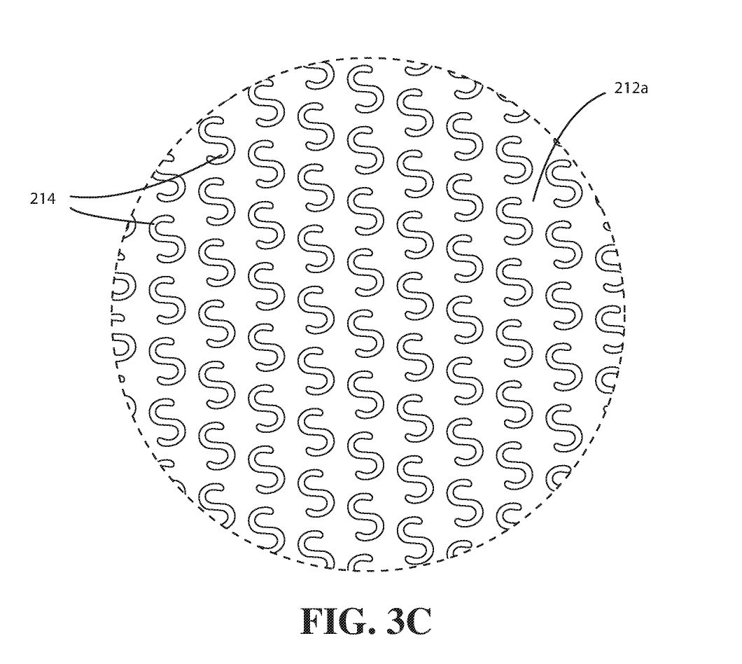

FIGS. 3-3C show a third embodiment of a cleaning wipe in accordance with an aspect of the invention, generally indicated at 210. Cleaning wipe 210 comprises a base layer 212 and a plurality of nodules 214 that may be provided on the base layer 212. Base layer 212 may be a non-woven, spunlace fibrous material. The fibrous material may be comprised of about 50% viscose and about 50% polyester or any other suitable material. FIG. 3 illustrates base layer 212 as being square in shape but it will be understood that base layer 212 may be provided in any desired shape. As illustrated, base layer 212 has a front surface 212a, a back surface 212b (FIG. 3B), a first end 212c, a second end 212d, a first side 212e and a second side 212f.

A plurality of nodules 214 is provided on base layer 212. Nodules 214 may be formed from any suitable material such as polyvinyl chloride (PVC) or rubber and may be applied, bonded or embedded in one or both of front surface 212a or back surface 212b of base layer 212.

In accordance with an aspect of the present disclosure, nodules 214 may be provided on base layer in a different pattern from the patterns shown in FIGS. 1 and 2. FIG. 3C shows that each nodule 214 is generally S-shaped. The S-shaped nodules 214 may be arranged in a plurality of substantially parallel rows 216a, 216b, and 216c and so on that are angled relative to first end 212c of base layer 212. Each nodule 214 is a raised member that presents faces that extend for a distance outwardly beyond the respective front surface 212a and/or back surface 212b upon which nodule 214 is provided. Nodules 214 in adjacent rows, such as 216a and 216b may be laterally offset relative to each other meaning the “S”-shapes of the nodules are not perfectly aligned with each other. Nodules 214 in every second row, such as 216a and 216b, may be laterally aligned with each other. Nodules 214 thus present a plurality of curved faces that are oriented at a variety of different angles relative to each other. Cleaning wipe 210 is used in substantially the same manner as cleaning wipe 10 or cleaning wipe 110. Because of the variety of differently oriented and angles faces presented by nodules 214, when cleaning wipe 210 is used on a grill surface, nodules 214 will engage and scrape off particles of food, small pieces of food, grease, grime or other materials bonded or stuck to the grill surfaces. As with the cleaning wipes 10 and 110, increased tackiness from being heated causes nodules 214 to drag and capture stuck on particles of food and other materials from the grill.

It will be understood that any number of other differently shaped nodules may be provided on base layer 12 arranged in any one of a number of differently configured patterns. For example, nodules may be circular in shape, or X-shaped, E-shaped, etc. Furthermore, a combination of more than one differently shaped nodule may be utilized on any one cleaning wipe. For instance, a combination of the nodule 14, 114 and or 214 or other shapes may be provided on a single base layer. The surfaces of the various nodules which extend outwardly from the front surface and/or back surface of the base layer may be oriented generally at right angles to the front or back surface, or may be oriented at an obtuse angle or an acute angle, or may be curved relative to the front or back surface. Whatever shape the nodules take and whatever angle the nodule faces and surfaces are oriented at, the nodules are provided to aid in removing material from a grill surface when the cleaning wipe is pushed or pulled across that grill surface.

Furthermore, one or both of base layer 10, 110, 210 and nodules 14, 114, 214 may include a plurality of abrasive particles 20 (FIG. 1D) therein. Some of these particles 20 may be present in the exterior surface of the base layer or in the body of the nodules. In other words, the non-woven spunlace fabric used as the base layer and/or the PVC or rubber used in the nodules may include abrasive particles therein. The particles 20 will produce a scouring effect when cleaning wipe 10 is moved across a grill surface. The abrasive particles 20 may provide a more aggressive cleaning surface on cleaning wipe 10 so as to more effectively clean food matter, grease, grime, and other materials from a grill surface.

It is contemplated that a new cleaning wipe 10, 110, 210 will be used every time a BBQ grill is cleaned. This aids in ensuring that a user does not clean their BBQ grill with a dirty, previously used cleaning implement. Obviously, this methodology will result in a more sanitary cooking environment for the user.

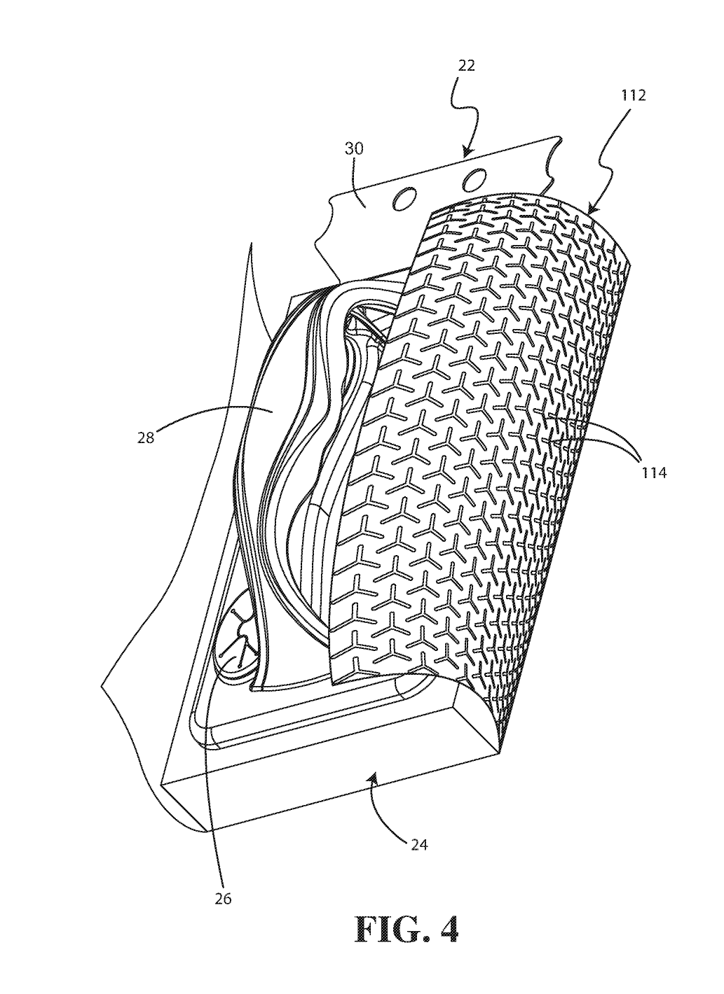

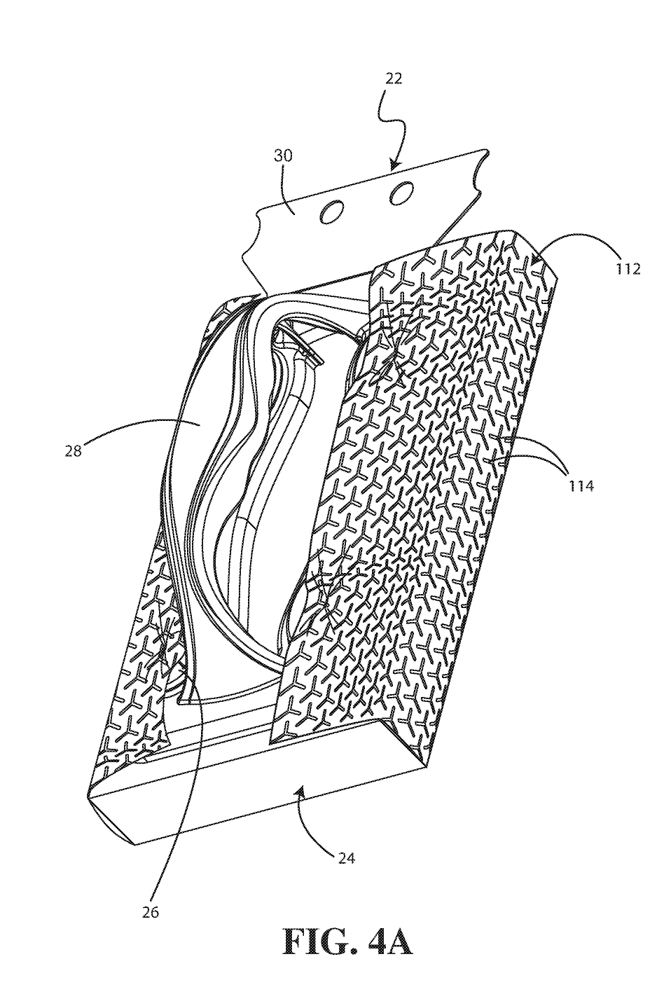

FIGS. 4 and 4A show one of the cleaning wipes of FIG. 1 or 2 or 3 engaged with a support device 22. Support device 22 includes a support member 24, one or more fastening elements 26, and a handle 28. The fastening elements 26 may be in the form of gripping members 26. Support device 22 may also include a scraper 30. Handle 28 includes a base 28a to which support member 24 is engaged. Gripping members 26 are provided on an upper surface of base 28a. Handle 28 is ergonomically designed to be easy to grip.

Support member 24 may be a scouring pad or brush that presents an exterior texture that tends to engage and secure the fabric used in cleaning wipe 10, 110, 210 thereto. Gripping members 26 hold the edge regions of cleaning wipe 10, 110, 210 firmly therein. Cleaning wipe 10, 110, 210 as described herein may be engaged for a single use with the support device 22 and this allows the cleaning wipe to be safely brushed up against the surface of a hot grill, thereby reducing the risk that the user's hand will accidentally contact the hot grill surface and become injured.

Cleaning wipe 110 is shown in FIG. 4A frictionally engaged with an exterior surface of pad 24 of support member 22. Pad 24 may include a gripping surface, a hook and loop type surface or any other type of texturing or exterior surface or fastening element that engages the fabric of cleaning wipe 110 and holds onto the same. FIG. 4B shows cleaning wipe 110 wrapped around pad 24 and secured to support member 22 by way of the plurality of gripping members 26. Gripping member 26 as illustrated are generally circular in shape and include a plurality of flexible tabs that are radiate outwardly from a central region of the gripping member 26. The cleaning wipe 110 is pushed into engagement with the bottom of the pad 24 and the edges and sides of the cleaning wipe are wrapper around the sides and onto the top of the pad 24. A portion of the cleaning wipe 110 is placed over each of the gripping members 26. The user will use a finger to push the portion of the cleaning wipe inwardly into each gripping member 26 so that some of the tabs thereof flex inwardly out of the way and then rebound to capture the portion of the cleaning wipe therebetween. Once cleaning wipe 110 is engaged with support member 22 the user will grip the handle 28 and will manipulate support member 22 to sweep cleaning wipe 110 over a BBQ grill surface and thereby clean food particles and other materials off that surface.

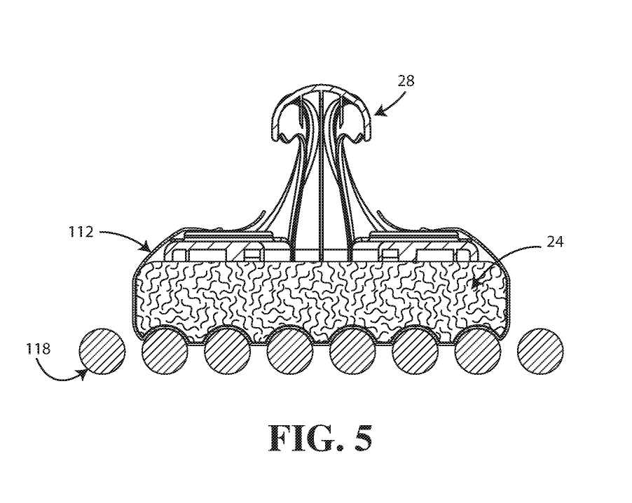

FIG. 5 is a cross-section showing the cleaning wipe 110 wrapped around pad 24 of support member 22 and being brought into contact with a plurality of grill bars 118 of a BBQ grill. It should be noted that the cleaning wipe 110 and pad 24 tend to conform to the contours of the bars 118 and are therefore more effective at cleaning the same. PRIOR ART non-metallic BBQ cleaning pads tend to be a trap for grease and grime and are therefore not sanitary. The combination of support member 22 and the cleaning wipe 10, 110 or 210 are far more sanitary than were PRIOR ART devices since, after use, the cleaning wipe 10, 110 or 210 is disengaged from support member 22 and is thrown away. Since the cleaning wipe 10, 110 or 210 is removed from support member 22 and is disposed of, repeat cleaning of bars 118 is more sanitary than was previously possible.

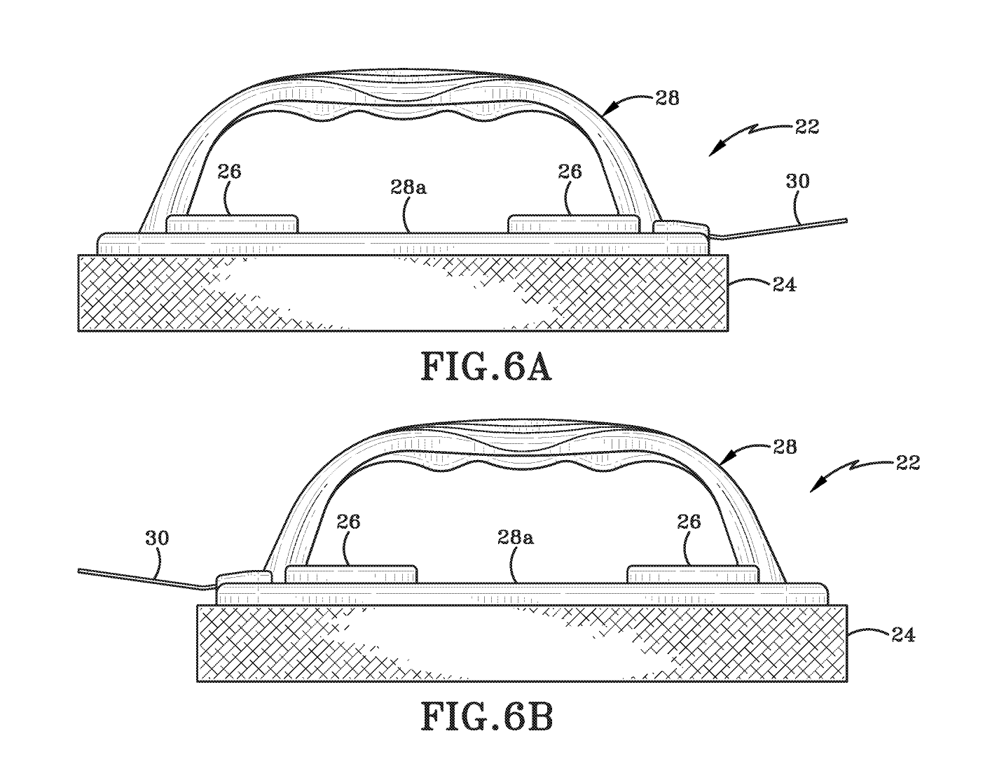

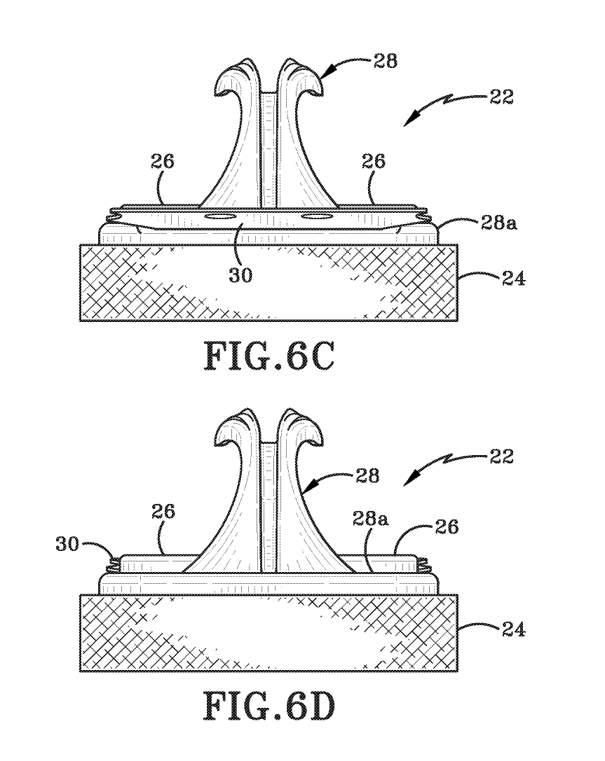

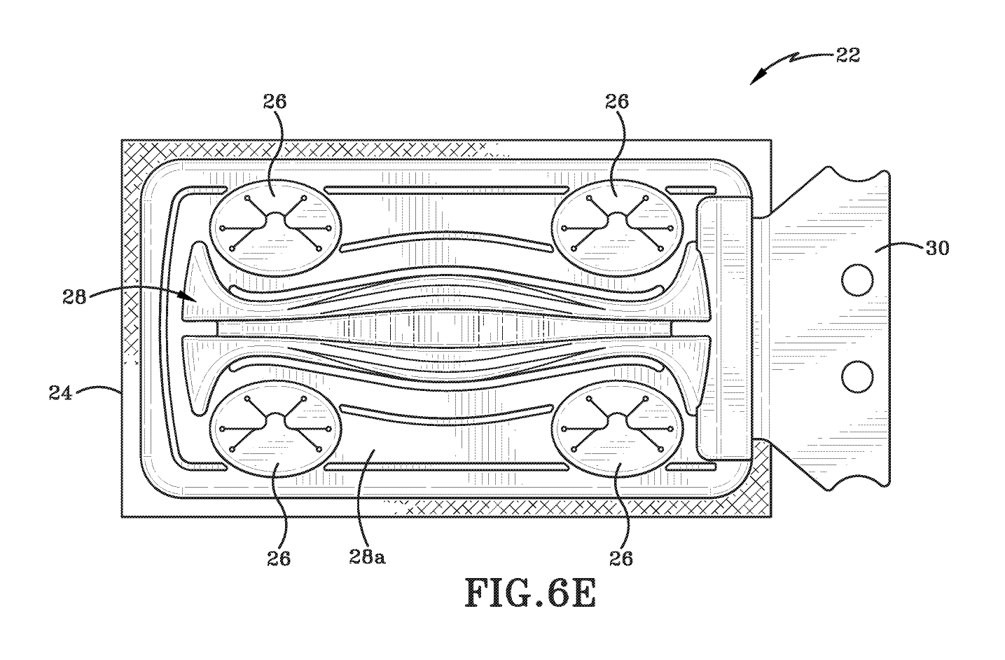

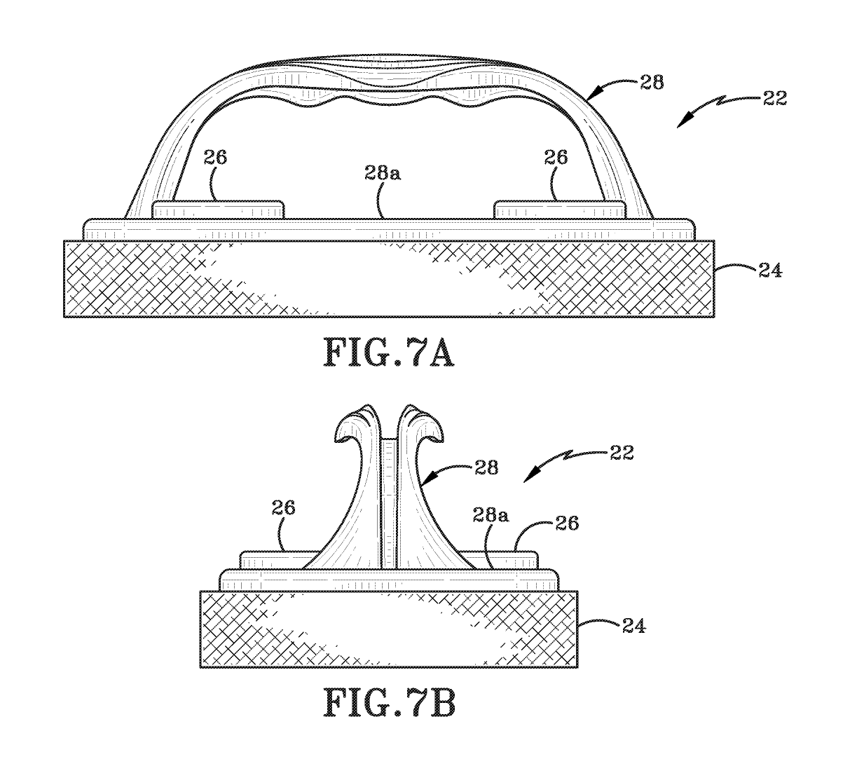

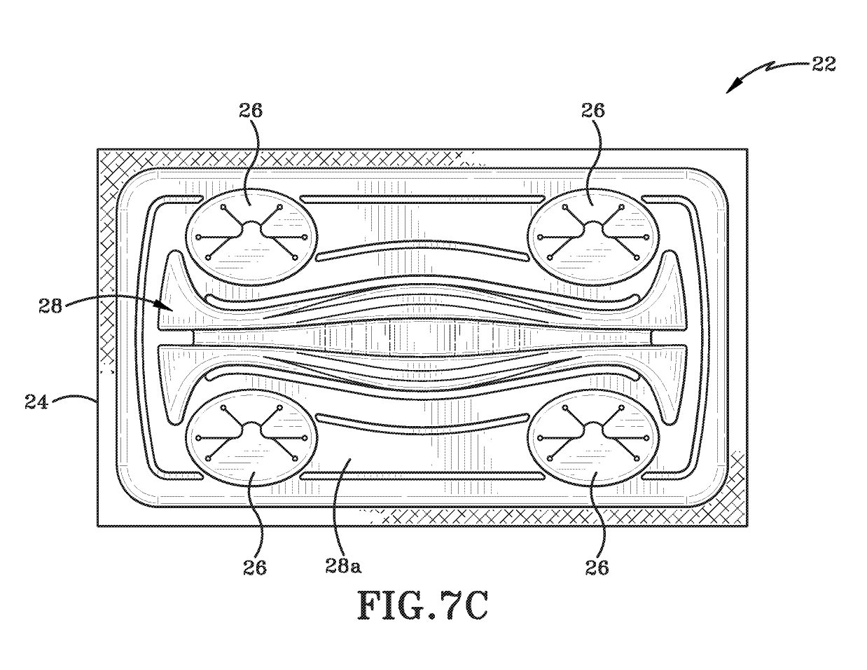

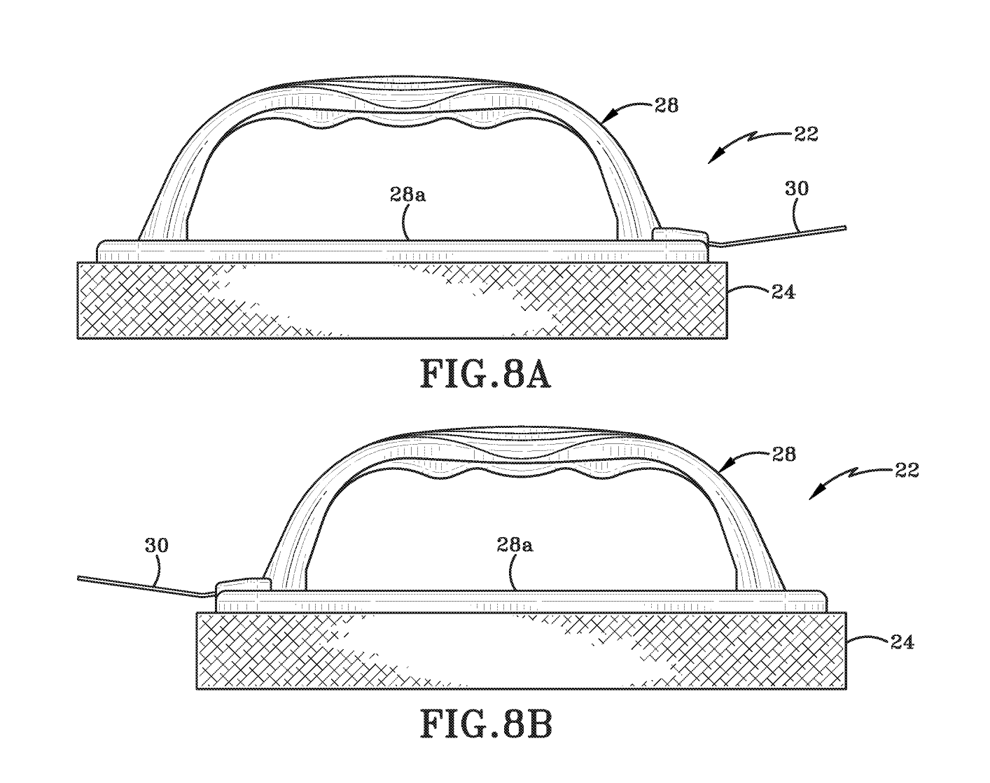

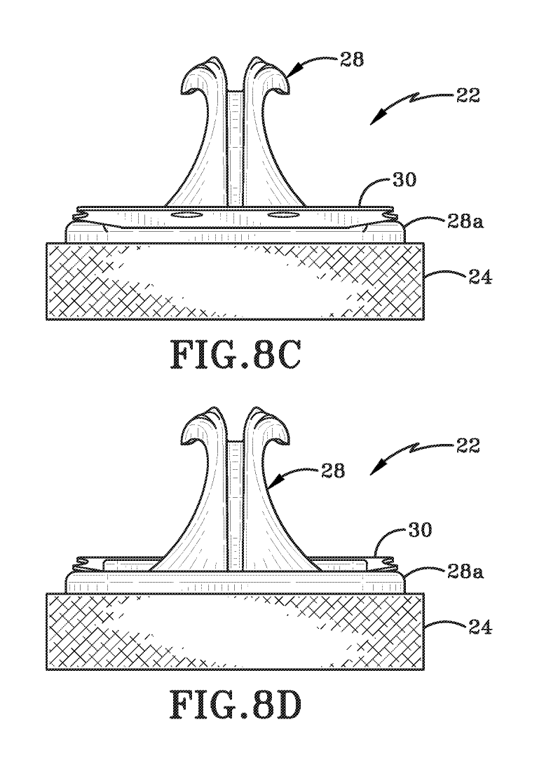

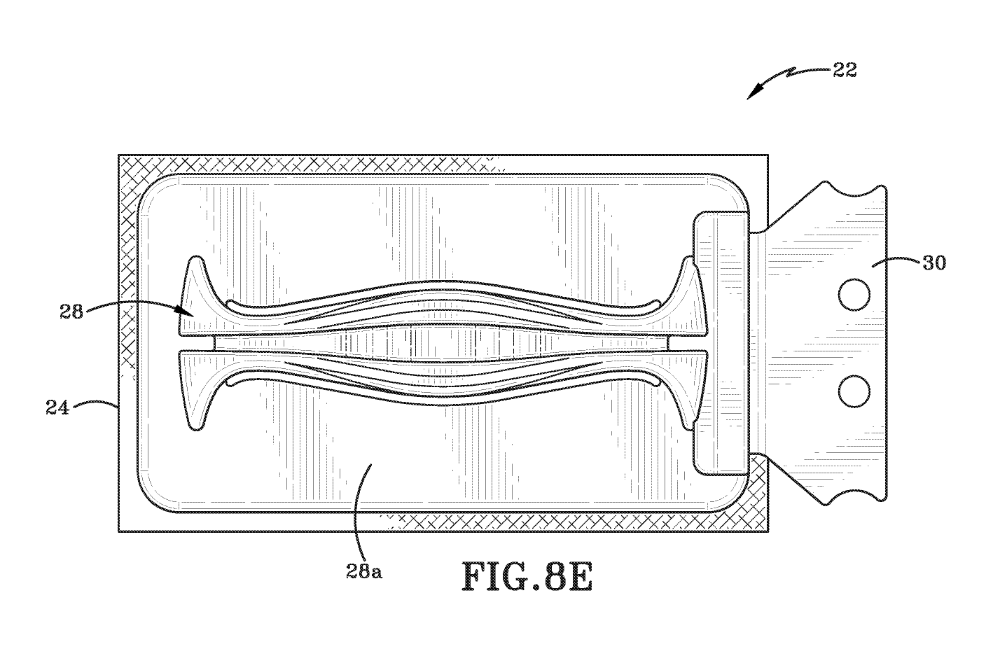

FIGS. 6A to 6E show the support member 22 in greater detail. FIGS. 7A to 7C show a second embodiment of the support member 22. This second embodiment is substantially identical to the support member shown in FIGS. 6A to 6E except that the scraper 30 is omitted therefrom. FIGS. 8A to 8C show a third embodiment of the support member that is substantially identical to the support member shown in FIGS. 6A to 6E except that the gripper elements 26 are omitted therefrom.

It will understood that while the cleaning wipe has been described for use in cleaning BBQ grill surfaces, the cleaning wipe disclosed herein could be used to clean oven surfaces, surfaces of stoves, counters, work benches, walls, or any other places where materials may become stuck both in the home and out of the home.

It will further be understood that one side of cleaning wipe 10, 110 or 210 may be free of nodules or that the front surface and the back surface of the cleaning wipe may have different shape or size nodules from the other surface thereof. It is further contemplated that other desired shapes, patterns, or sizes of nodules may be provided on one or both of the front and back surfaces of the cleaning wipe or that more than one shape, pattern, or size nodule can be applied on the same surface of the cleaning wipe.

In the foregoing description, certain terms have been used for brevity, clarity, and understanding. No unnecessary limitations are to be implied therefrom beyond the requirement of the prior art because such terms are used for descriptive purposes and are intended to be broadly construed.

Moreover, the description and illustration set out herein are an example and the invention is not limited to the exact details shown or described.

1. A cleaning wipe for removing stuck materials from an object's surface, said cleaning wipe comprising:
a base layer having a front surface and a back surface; and
a plurality of nodules extending for a distance outwardly from one or both of the front surface or the back surface of the base layer.

2. The cleaning wipe as defined in claim 1, wherein the plurality of nodules is arranged in a pattern.

3. The cleaning wipe as defined in claim 1, wherein the base layer is comprised of a non-woven, spunlace material.

4. The cleaning wipe as defined in claim 1, wherein each of the plurality of nodules is comprised of a polyvinyl chloride material or a rubber material.

5. The cleaning wipe as defined in claim 1, wherein one or both of the base layer and the plurality of nodules includes an abrasive material.

6. The cleaning wipe as defined in claim 1, wherein each nodule of the plurality of nodules is generally oval or rectangular in shape and includes at least one face that extends outwardly from the one of the front surface or the back surface of the base layer for a distance.

7. The cleaning wipe as defined in claim 6, wherein the plurality of nodules is arranged in a plurality of rows on the base layer.

8. The cleaning wipe as defined in claim 7, wherein the plurality of rows are diagonal rows extending between a first end and a second end of the base layer.

9. The cleaning wipe as defined in claim 7, wherein each of the plurality of rows includes a first group of nodules arranged in a first orientation and a second group of nodules arranged in a second orientation that is different from the first orientation.

10. The cleaning wipe as defined in claim 9, wherein nodules of the first group of nodules are alternated with nodules of the second group of nodules in each of the plurality of rows.

11. The cleaning wipe as defined in claim 9, wherein the first orientation is generally at right angles to the second orientation.

12. The cleaning wipe as defined in claim 1, wherein each nodule is Y-shaped.

13. The cleaning wipe as defined in claim 12, wherein the nodules are oriented in rows and wherein nodules in adjacent rows of nodules are laterally offset relative to each other.

14. The cleaning wipe as defined in claim 1, wherein each nodule is S-shaped.

15. The cleaning wipe as defined in claim 14, wherein the S-shaped nodules are oriented in rows.

16. The cleaning wipe as defined in claim 15, wherein S-shaped nodules in adjacent rows of nodules are laterally offset relative to each other.

17. In combination:
a support device; and
a cleaning wipe for removing stuck materials from an object's surface, said cleaning wipe comprising:
a base layer having a front surface and a back surface; and
a plurality of nodules extending for a distance outwardly from one or both of the front surface or the back surface of the base layer; and
wherein the cleaning wipe is selectively detachably engaged with the support device.

18. The combination as defined in claim 17, wherein the support device includes a pad and the cleaning wipe is wrapped at least partially around the pad and wherein the pad and cleaning wipe are adapted to contour to at least one BBQ grill bar.

19. The combination as defined in claim 18, further comprising a fastening element for temporarily securing the cleaning wipe to the pad.

20. A method of removing stuck materials from an object's surface comprising:
providing a cleaning wipe;
moving the cleaning wipe across the object's surface;
contacting the materials stuck on the object's surface with a plurality of nodules that extend for a distance outwardly from a front surface or a back surface of the cleaning wipe; and
scraping the stuck materials from the object's surface using the plurality of nodules and the front surface or the back surface of the cleaning wipe.

21. The method as defined in claim 20, further comprising:
providing the plurality of nodules in a pattern on the front surface or the back surface of the cleaning wipe.

22. The method as defined in claim 20, further comprising:
orienting a first face of each of the plurality of nodules at a different angle relative to a second face of the each of the plurality of nodules.

23. The method as defined in claim 20, further comprising:
providing abrasive particles in the plurality of nodules or in a base layer of the cleaning wipe; and
scraping the abrasive particles provided in the plurality of nodules or in the base layer across the stuck materials on the object's surface.

24. The method as defined in claim 20, further comprising:
providing a support device;
engaging the cleaning wipe on the support device; and
holding the support device to manipulate the cleaning device during a cleaning operation.
